(19) United States
(12) Patent Application Publication
(10) Pub. No.: US 2025/0247622 A1
(43) Pub. Date: Jul. 31, 2025

(54) Method for efficient calculation of video motion vectors

(71) Applicants: Daniel Hofman, Zagreb (HR); Srdan Kovacevic, Osijek (HR); Jakov Benjak, Zagreb (HR)

(72) Inventors: Daniel Hofman, Zagreb (HR); Srdan Kovacevic, Osijek (HR); Jakov Benjak, Zagreb (HR)

(21) Appl. No.: 18/948,575

(22) Filed: Nov. 15, 2024

Related U.S. Application Data
(60) Provisional application No. 63/599,132, filed on Nov. 15, 2023.

(51) Int. Cl. H04N 23/69; H04N 19/56

(52) U.S. Cl. CPC H04N 23/69; H04N 19/56

(57) ABSTRACT

In short, the disclosed method incorporates a novel algorithm for optimizing Motion Estimation (ME) for the compression of video originating from cameras mounted on remotely controlled vehicles (RCVs), and devices, with a particular focus on unmanned aerial vehicles (UAV). The basic embodiment enabled by the present invention leverages information about vehicle motion dynamics estimated by the controller/estimator block of the vehicle's control system to estimate the motion of the vehicle between two successive frames and use that information to more efficiently determine the Motion Vectors (MV) for each block in a frame. These and other embodiments are described in more detail in the description.

### BACKGROUND OF THE INVENTION

The problem of motion estimation (ME) for unmanned aerial vehicles (UAVs), and in general for video enabled devices in motion, has been a topic of significant interest in recent years. Because the speed and accuracy of the processing of image data are crucial for user controlled and remote piloting of devices in motion, a key focus has been on improving the efficiency and accuracy of block-matching algorithms for determining the Motion Vectors (MVs) in ME.

ME is a critical component in many video processing applications, such as video compression, object tracking, and video stabilization. ME works by predicting the movement of objects within video frames, allowing for more efficient data encoding and transmission. Common ME algorithms include Full Search (FS), Diamond Search (DS), Hexagonal Search (HS) and Test-Zone Search (TZS), each offering a different trade-off between computational complexity and accuracy. FS, while the most accurate, is computationally intensive, making it less suitable for real-time applications. DS, HS, and TZS, on the other hand, provide faster computations with slightly lower accuracy, making them more practical for applications requiring low latency.

Researchers A. V. Paramkusam, N. K. Darimireddy, B. Sridhar, and S. Siripurapu, in their paper “All directional search motion estimation algorithm,” Electronics 2022, Vol. 11, Page 3736, vol. 11, p. 3736, 112022, proposed an All-Direction Search (ADS) pattern, which searches for the best block in all possible directions. This approach however is computationally expensive and results in unnecessary coding latency.

Wang and Yang proposed an improved fast ME algorithm for H.266/VVC, where they replaced the DS model with a Hexagonal Search (HS) model. They also increased the number of initial matching search points of the rotation HS model, which led to a significant reduction in the overall coding time; however, introducing additional search points also included new unnecessary search points that could have been detected using the information about the camera/UxS movement.

Nalluri P., Alves L. and Navarro A. proposed improvements to some fast ME algorithms to achieve a novel fast hybrid algorithm. Their proposed algorithm achieves up to a 44.7% decrease in ME complexity when compared to fast ME algorithms, which is lower than the decrease achieved with the present method.

The problem solved by the MDIS method however is a minimization of the number of locations that will be searched in the ME process thereby resulting in fewer searches, which means fewer operations in the encoding process. This optimization maintains video quality but increases the encoding speed and reduces latency. To the best of the applicant's knowledge, no other invention or research leverages user input from the controller to optimize ME algorithms.

Hassan and Butt studied the effects of a meta-heuristic algorithm on ME. They proposed the Firefly algorithm for ME, which saved a considerable amount of time with a comparable encoding efficiency. Multiple other ME optimizations have also been successfully implemented.

In the realm of user interaction, Yu et al. presented EyeRobot, a concept that enables dynamic viewpoints for telepresence using the intuitive control of the user's head motion. This approach could potentially be adapted for the MDIS ME method.

Yoo et al. proposed a hybrid hand-gesture system that combines an inertial measurement unit (IMU)-based motion capture system and a vision-based gesture system to increase real-time performance. Their approach divided IMU-based commands and vision-based commands according to whether drone operation commands are continuously input.

The work by Varga et al. on the validation of a Limit Ellipsis Controller (LEC) for rescue drones presents an innovative control algorithm designed for UAVs in emergency situations. In their study, the LEC was adapted for indoor environments, showcasing its potential to improve drone stability and maneuverability in semi-structured settings.

Similarly, previous research also illustrates the significant utility of unmanned vehicles, unmanned aerial vehicles, and drones in outdoor safety and rescue operations, particularly in expediting the search for missing persons.

The real-time video feed provided by UAVs is essential for drone pilots, and users of unmanned vehicle systems, to make timely and informed decisions. In these scenarios, it is critical that the video feed is both promptly available and of high quality.

The present method innovates upon these pre existing approaches in a novel way by optimizing the ME in both the visual and thermal camera equipped on the unmanned vehicle or device.

The MDIS method addresses the requirements of real time video feed processing by enhancing the overall encoding speed, thereby ensuring quicker end-to-end video transmission. Generally, the present invention is implemented to generate ME across various applications, and industries including military, delivery, construction, agriculture, or mining.

### BRIEF DESCRIPTION OF DRAWINGS

FIG. 1 Example search points for finding the best motion vector.

FIG. 2 Diagram illustrating drone movement: axes denote the direction of linear motion, and arrows indicate rotational movements (roll, pitch, and yaw).

FIG. 3 Visual representation illustrating pixel displacement towards the edges during forward drone motion.

FIG. 4 Forward drone motion example, highlighting the effect of pixels expanding from the center toward the image edges.

FIG. 5 Visual representation of pixel trajectories during a drone's right yaw rotation.

FIG. 6 Search locations in Diamond Search (left) and potential search locations in MDIS (right).

FIG. 7 Discrete forward motion search model, depicting selective search patterns based on block positions in an image.

FIG. 8 Set of probability functions determining search locations in forward motion, based on block position within the image.

FIG. 9 Visualization of motion vectors resulting from forward motion, showcasing directional pixel displacement.

FIG. 10 Discrete search model for leftward drone motion, illustrating search pattern adjustments based on an image block position.

FIG. 11 Set of probability functions determining search locations in left motion, based on block position within the image.

FIG. 12 Definition of the functions local_thresh and thresh.

FIG. 13 Flowchart depicting the widely recognized process flow of ME in the HEVC algorithm.

FIG. 14 HEVC AMVP scheme showing red rectangles as spatial candidates from the same frame and green rectangles as temporal candidates from different frames.

FIG. 15 Comparative visualization of search patterns: DS algorithm blocks on the left, showcasing a traditional search approach, contrasted with Motion Dynamics Input Search (MDIS) algorithm blocks on the right, demonstrating the adaptive search based on user input and motion dynamics.

FIG. 16 An example of a video frame being divided into multiple CUs.

FIG. 17 Simplified diagram of a video coding framework incorporating the Motion Dynamics Estimator Block, illustrating its role in enhancing ME.

FIG. 18 Mapping of movement codes to descriptions.

### SUMMARY OF THE INVENTION

This application introduces a method incorporating a novel ME algorithm, Motion Dynamics Input Search (MDIS), which builds upon the foundation of the well-known DS algorithm while incorporating motion dynamics estimation that responds to real-time user interaction with the controller.

Instead of searching all the points of the diamond for each block, MDIS only searches the selected locations based on the user input from the controller. Additionally, the search range is modified based on the location of the pixel in the image and the current drone movement type. While our disclosure is centered on UAVs and FPV systems, the MDIS method can be applied to any system incorporating user controls including hand controlled vehicles and devices as well as remotely controlled vehicles and devices.

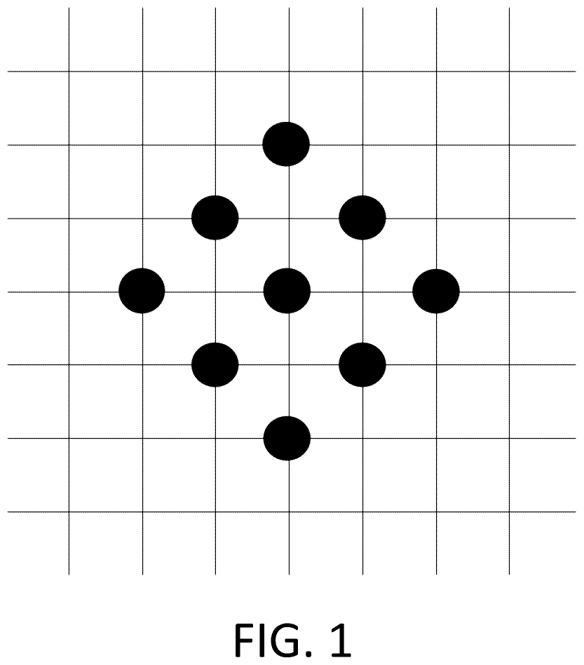

The MDIS method is used to create motion vectors (MV) efficiently. In prior art, MV were created using motion estimation (ME) search algorithms (such as Diamond search, Hexagonal search, etc.). When searching for the best MV of a frame block the search is performed starting with some initial search points. Example search points are shown in FIG. 1.

The problem of ME in general and for UAVs has been a topic of significant interest in recent years. A key focus has been on improving the efficiency and accuracy of block matching ME algorithms.

Researchers proposed an All-Direction Search (ADS) pattern, which searches for the best block in all possible directions. To further improve search speed, a halfway stop technique was applied in the search process.

The results showed that the proposed ADS algorithm outperformed other state-of-the-art and eminent ME algorithms. This work is particularly relevant as it presents the most effective approach to block-matching that can potentially enhance the performance of the DS algorithm.

The present method aims to be even more effective in addressing the challenge of reducing search locations in the ME process by leveraging user inputs. In an earlier embodiment, we developed a basic version of the Motion Dynamics Input Search (MDIS) method, called User Input Search. To our knowledge, no other invention has optimized ME algorithms based on user input.

MDIS is a novel method for optimizing ME for Remotely Controlled Vehicles (RCVs), with a particular focus on UAVs. Unmanned Aerial Vehicles (UAVs) are increasingly being used in a variety of applications, including for policing, military or defense purposes, as well as entertainment, surveillance, and delivery. However, the real-time ME of UAVs is challenging due to the high speed and unpredictable movements of these vehicles.

The proposed method, MDIS, incorporates information from motion dynamics estimation to enhance the accuracy and efficiency of ME, generally, and can be applied to both remotely controlled vehicles as well as any other user controlled devices in motion, whether the user is physically present or located remotely.

The MDIS method addresses the challenges associated with real-time ME by leveraging user input to guide the search for the most similar blocks in the previous video frame.

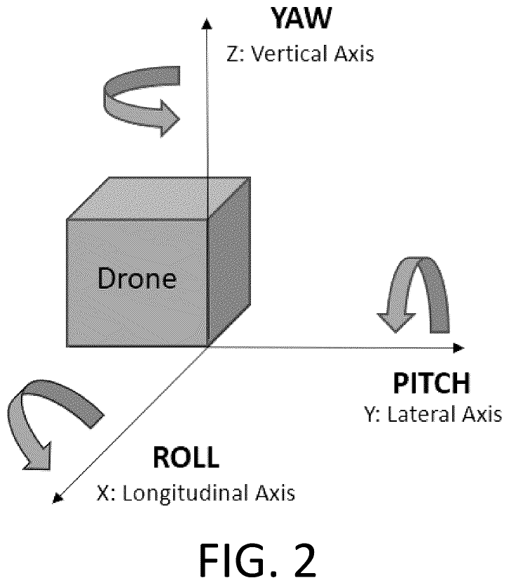

The movement of a vehicle or device in motion can be described by a combination of linear and angular motion in different dimensions. When it comes to drones, linear motion can be decomposed into velocity vectors, each parallel to one of the three axes (x, y, and z), while the angular motion can be decomposed into three rotational components, each around one of the three axes. (FIG. 2)

Each rotational component of an aerial vehicle has a specific name: the rotation around the Longitudinal Axis of the vehicle (axis X) is called “roll”, the rotation around the Lateral Axis of the vehicle (axis Y) is called “pitch”, while the rotation around the axis vertical to the vehicle (axis Z) is called “yaw”.

In the case of drones, the most common movement in drone scenes is the forward movement, which requires the drone to slightly pitch. When the drone moves forward, pixels tend to spread away from the center of the image in FIG. 3.

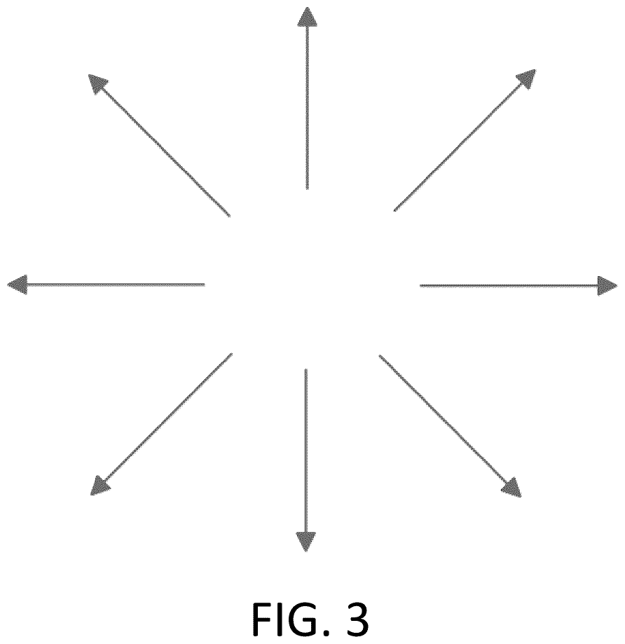

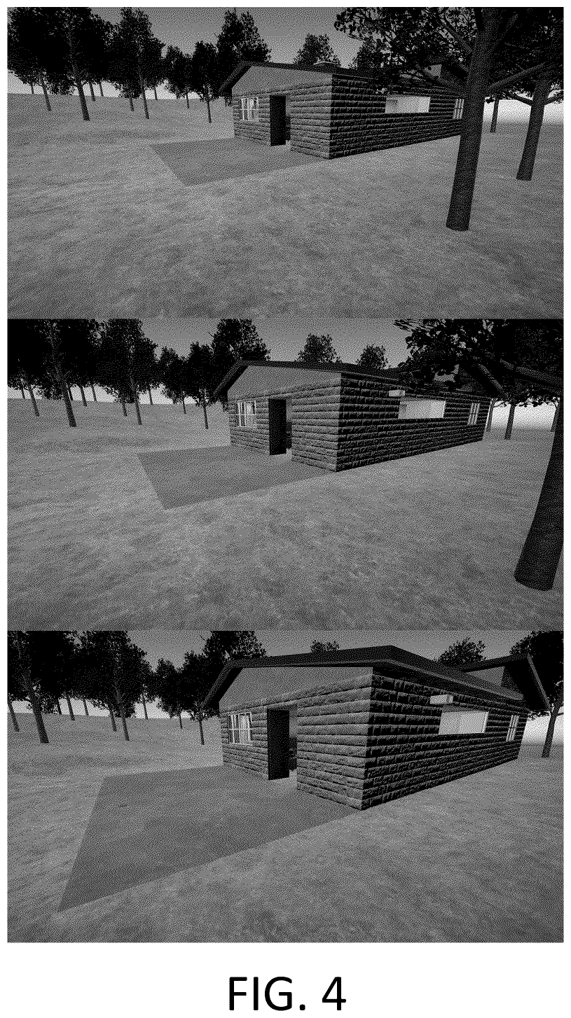

The further away the pixel is from the center, the more it will expand (move toward the corner of the image) in the next frame. An example of a drone forward motion in a simulator can be seen in FIG. 4.

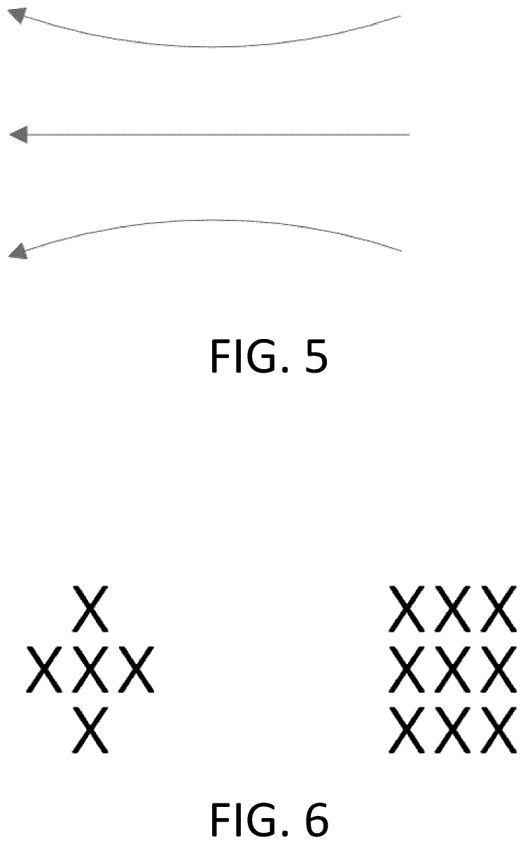

Similarly, when the drone moves backwards, pixels compress toward the center of the image. The next movement type is the yaw rotation movement. When the drone rotates to the right, pixels tend to follow the movement scheme illustrated in FIG. 5.

Pixels located closer to the top or bottom of the image exhibit a more pronounced arc in their movement, while pixels located in the center of the image move in a straight line. Of course, when the drone is rotating to the left, the pixels move to the right, and vice versa for the right rotation. Additionally, the arc angle depends on the camera lens characteristics.

Pixel movements are much simpler when it comes to left-right and up-down drone motion. When the drone moves to the left it must perform a slight roll rotation first, and afterward, the pixels move straight to the right. If the drone is in an upward motion, the pixels move straight downwards. Hence, no complex search models were created for the roll and throttle movements. Simply, only the diamond locations that match the current direction of the drone motion are searched by MDIS.

### DETAILED DESCRIPTION

The MDIS model was designed with the described pixel movements in mind. The model creation starts by segmenting the image into nine equal regions. This is achieved by partitioning both the vertical and horizontal axes into three equal segments, resulting in a 3×3 grid.

The next step is determining which diamond locations should be searched in each of the nine segments. We developed a few search model versions which varied in several parameters.

For example, in one version of MDIS, the diamond shape is extended so that it also includes corner locations (FIG. 6). Different versions also varied in parameters such as the weight in the weighted probability function, or the probability threshold, described later on.

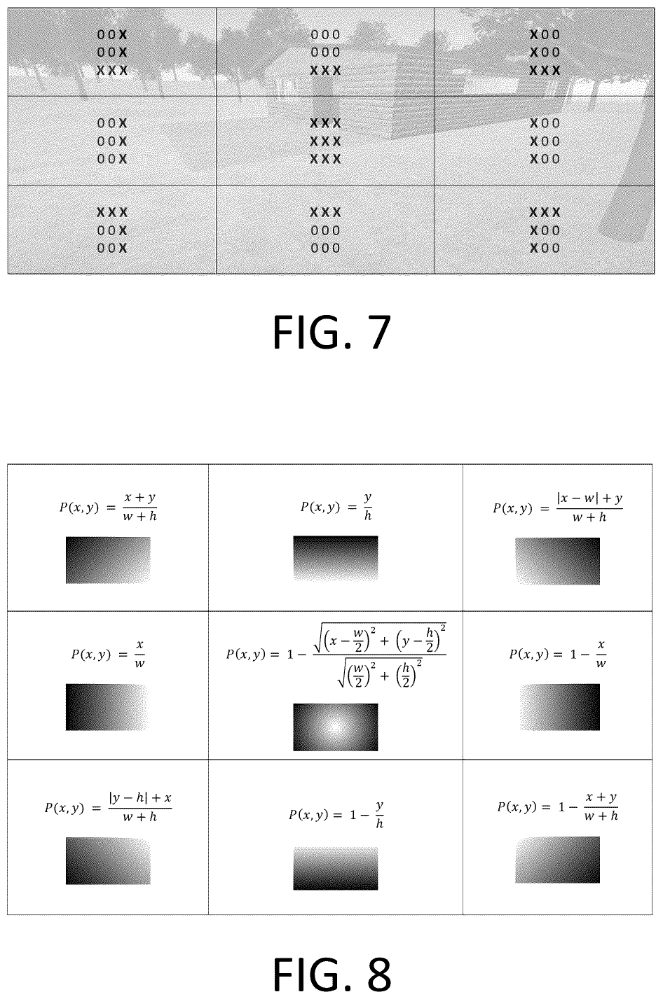

The general model design process will be described through the forward motion model. The search model for left-right motion is created analogously. FIG. 7 shows the forward motion search model in MDIS.

The whole box represents a single image, which is segmented into nine segments, as explained earlier. In each segment, a modified diamond shape is drawn, where locations marked with ‘X’ represent locations that should be searched, and locations marked with ‘0’ represent locations that should be skipped. In other words, depending on the block location in the image, some search locations will be included and some will be excluded.

For example, in the forward motion search model shown in FIG. 7, blocks that belong in the center grid segment are searched for the most similar block in all possible directions. Similarly, blocks in the upper-left grid segment are only searched in the right and bottom directions. In this particular case, the diagonal search locations are also shown, which can be excluded in some search models.

We call this model the Discrete search model (DSM). While MDIS could be implemented following DSM, we decided to improve it by creating the so-called Continuous Search Model (CSM). Instead of simply deciding whether a certain location should be searched depending on the block location, the CSM calculates the search probability for each search location.

The search probability is calculated based on the block coordinates, and each search location uses a different function, inspired by the DSM. All the functions for each search location in a forward motion are displayed in FIG. 8. Every function was crafted to emulate the DSM location-filtering approach, with an additional goal of functions having minimal computational complexity.

The variable x denotes the x-coordinate of the upper left corner of the current block, while y denotes the y-coordinate of the same corner. w stands for the picture width, and h represents the picture height.

Each grid segment refers to one search location. The small grayscale images inside each grid segment represent the 2D probability functions—the brighter the area, the higher the probability. These grayscale images correspond to images themselves, in terms of resolution.

Looking at the upper left search location for example—the closer the block is to the bottom right corner of the image, the higher the probability that the upper left search location will be searched. This can be seen from the small grayscale image in the upper left grid segment—the closer the block is to the bottom right corner, the brighter it is. Search probabilities are calculated for each block independently.

At the start of the MDIS algorithm, the probability threshold is defined (0.5 for instance), and each search location that has a search probability higher than the probability threshold will be searched.

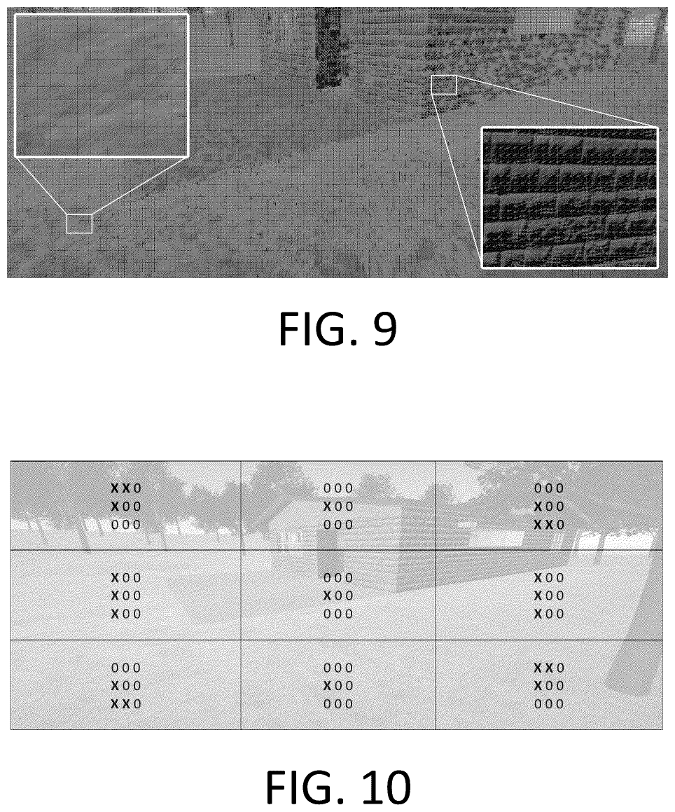

FIG. 9 is a snippet of MVs generated by the DS algorithm, in a case where the drone moved forward. This phenomenon consistently manifests whenever the drone advances, illustrating that MVs accurately adhere to the forward motion model outlined by MDIS. All the vectors point toward the center of the image.

One very important observation, which was discussed in the previous subsection, is that the further away the pixel is from the center, the more it will move towards the edge of the image. This is also considered in the search model. When searching for the most similar block, the search range is multiplied by the weighted probability function—the same probability function that was calculated earlier.

This is a great benefit of the CSM in comparison with the DSM. Not only do the probabilities determine whether the search location should be considered at all, but they also dictate the search range. This can also be seen in FIG. 9. Notice how blocks that are further away from the center have bigger MVs.

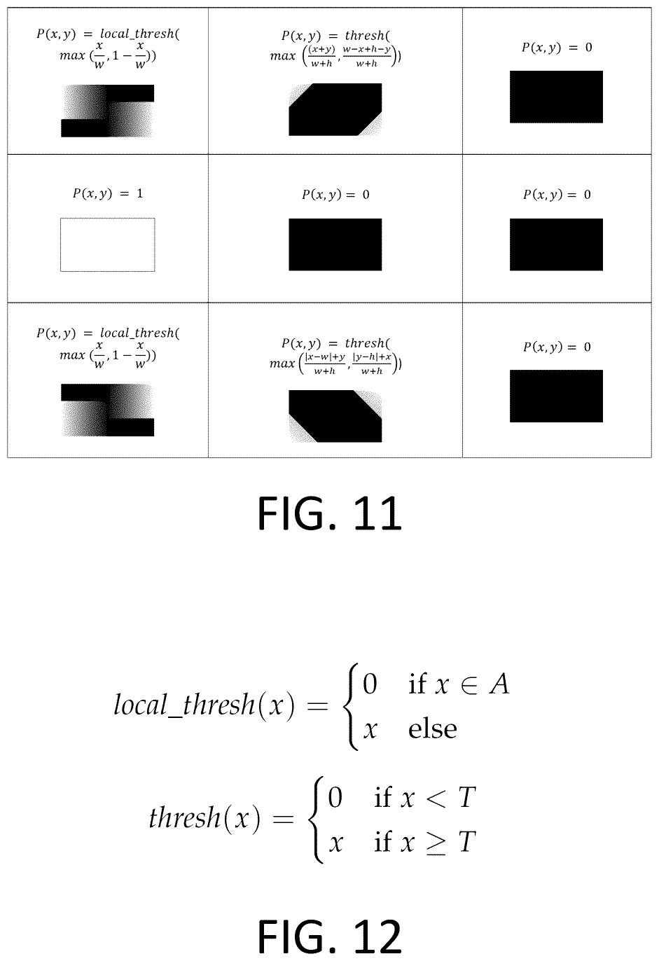

FIG. 10 shows the DSM for the left drone motion. The CSM was designed as well and is shown in FIG. 11.

Again, all the functions were designed with the intention of minimizing computational complexity, hence some functions have sharp transitions in probability values, even though there might be a better probability function available. The model for the right drone motion is analogous.

The function local_thresh sets all the values within a specified region to 0. The function thresh assigns a value of 0 to all elements that fall below a certain threshold. The parameter A from function (2) is a two-dimensional area representing a part of an image, and the parameter T is a scalar value. (FIG. 12)

In order to implement the method, an open-source High-Efficiency Video Coding (HEVC) video encoder, Kvazaar, was modified. Specifically, the DS algorithm, which is a part of Kvazaar's source code, was upgraded to incorporate MDIS. After conducting several preliminary tests, in which we encoded both simulator and real drone footage, we selected the DS algorithm that proved to be most suitable for the specific case used to verify and test the efficacy of the present invention.

Between DS, TZS, and HS, there was no clear winner in terms of encoding quality; the superior method varied depending on the specific content of the video being encoded, with the quality difference, measured in terms of PSNR, never exceeding 1.7%. In terms of compression ratio, TZS consistently demonstrated superior performance, with files encoded using TZS being on average 1.1% smaller than the smallest file produced by either DS or HS. Despite this, DS emerged as the fastest among the three, outperforming the TZS algorithm by an average of 56% and the HS algorithm by an average of 2.3%. DS's straightforward implementation in Kvazaar further solidified our choice.

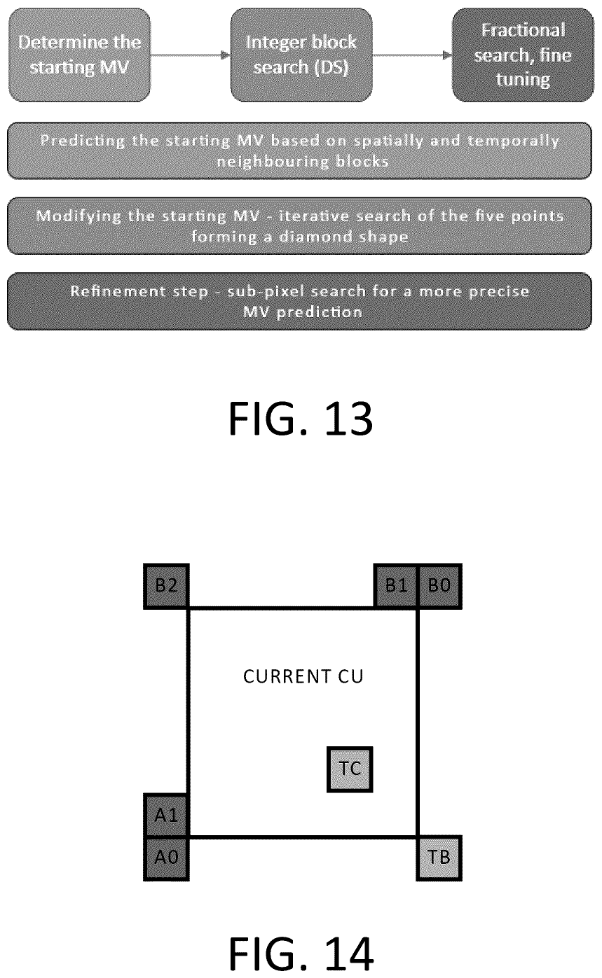

The research and testing phase showed that the DS and HS algorithms displayed comparable performance levels, whereas TZS appeared to prioritize a higher compression ratio while maintaining encoding quality, trading off increased encoding time. Kvazaar's ME algorithm flow with the use of DS is depicted in FIG. 13.

The first step is to determine the starting motion vector (MV), which is done with an Advanced Motion-Vector Prediction (AMVP). As described in published research on the subject, AMVP works by predicting the MV of a block in the current frame based on the MVs of spatially and temporally neighboring blocks. In FIG. 14, the candidates A0, A1, B0, B1, and B2 represent spatial candidates and TB and TC represent temporal candidates. This prediction is then used as a starting point for the ME process, which can significantly reduce the search time and computational complexity. AMVP is particularly effective in scenarios where the motion in the video is relatively consistent or predictable.

The next step is the inventive step, namely finding the best MV, by modifying the starting MV. This process is carried out by conducting an iterative search of the five points forming a diamond shape. The center is then shifted to the point with the best match. This iteration continues until the best match is found at the center point, or the number of steps has exceeded the step limit.

Searching for a single point refers to calculating the Sum of Absolute Differences (SAD) and comparing it with the current best SAD. The SAD is calculated as

$${{SAD ( A , B )}^{n m}}_{j = 1 j = 1} = \sum \sum \vert A ( i , j ) - B ( i , j ) \vert , \qquad ( 1 )$$

where A and B are matrices representing pixel values, or simply blocks being compared, and n and m represent the dimensions of the blocks. If the calculated SAD is lower than the best (lowest) SAD, then the current point becomes the best match. This second step is done on integer precision, or in other words, on a larger scale.

The last step is fine-tuning the MV, by performing a fractional search. A fractional search, also known as a sub-pixel search, is a refinement step in ME that allows for more precise MV prediction. After the best match has been found at an integer pixel position, a fractional search is conducted around this position at a sub-pixel level.

This is typically achieved by using interpolation methods to create a high-resolution grid between the integer pixels. The search is then conducted on this grid to find the best match with even greater precision. This process can significantly improve the accuracy of the MV and the overall quality of the video compression.

In MDIS, steps 1 and 3 are identical to those in the DS. The difference is in step 2, or the integer block search. The main idea behind the method is to consider the motion dynamics estimation that is influenced by user inputs received from the controller, and also some other case-specific parameters. The information received from the controller includes which joysticks were pushed at which video frame, as well as the push intensities.

For instance, if the drone is directed to move upwards, then it makes sense to focus the search only on the upside direction. The same goes with every other direction. The rationale behind this focused approach is the predominantly global nature of the movement in drone-captured footage, especially evident in drone racing scenes. In such scenarios, the drone's motion effectively dictates the movement trajectory of nearly every pixel within the frame, rendering a comprehensive search across all potential diamond locations unnecessary.

By knowing the object's directional movement within the current frame, MDIS optimizes the ME process by selectively searching only relevant diamond locations, thereby reducing both ME and overall encoding times.

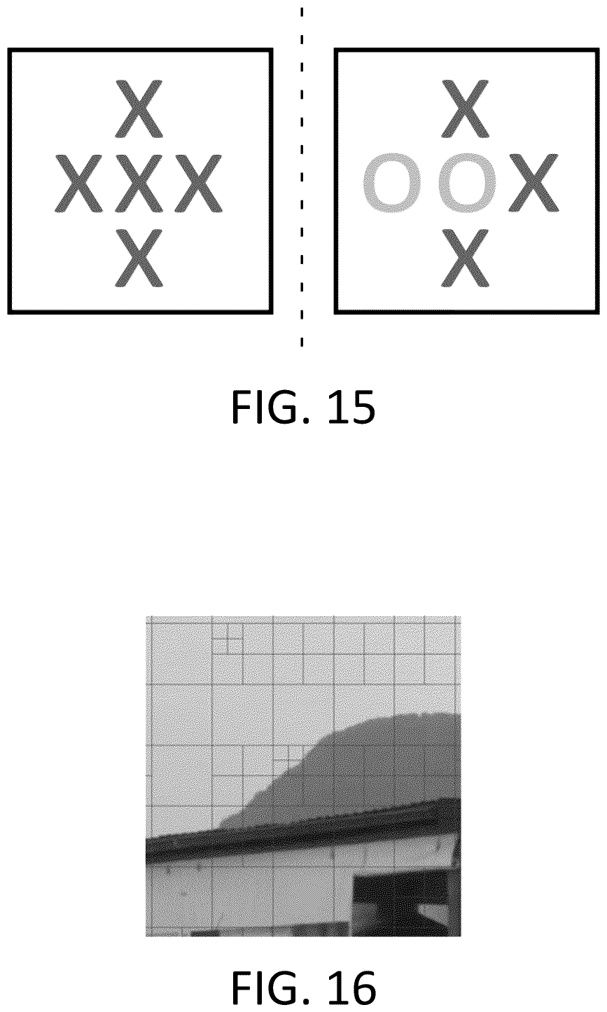

FIG. 15 illustrates the difference between searched locations in DS and MDIS method-locations marked with a red ‘X’ are searched, while the locations marked with a faded red ‘O’ are not searched in MDIS. In this particular case, the drone appears to be moving to the right, as evidenced by the exclusion of the left and middle search locations. This is merely one example; search locations can be selectively filtered based on the type of movement being analyzed.

### Using the MDIS Method to Perform Algorithm Search Block Probability Calculations

Once the encoder receives the drone's movement information—more specifically—the acceleration direction, the MDIS method algorithm determines the proper search model to be used in ME. The search model determines how the search probabilities will be calculated for each diamond search location. It differently calculates the search probabilities of each diamond location for each search model. Calculated search probabilities range from 0 to 1, and based on the defined probability threshold, certain search locations will be considered, and the other ones will be skipped.

The present method, MDIS, uses 9 different search models, depending on the current drone movement, or its acceleration: Undefined movement, forward and backward motion, moving to the left and to the right, upward and downward motion and lastly, rotating to the left and to the right. In case of undefined movement, a normal DS is used (all diamond locations are searched). All other cases use a different search model.

At the start of the algorithm, HEVC divides the video frame into multiple blocks, called Coding Units (CUs). All probabilities are calculated based on the CU (FIG. 16) location in the video frame (x and y coordinates of the upper left edge of the CU).

### How the MDIS Method Determines Search Locations

In the example provided, MDIS is being used to calculate the MV of a drone moving forward. Using MDIS, it is possible to calculate all the search probabilities for 2 CUs and determine which diamond locations will be searched and which will not for each CU. Let's assume the input video is in 4k (3840×2160 pixels) resolution.

The matrix in FIG. 8 represents the forward motion search model: X and y are the upper left CU coordinates, and w and h are frame width and height. To start, the encoder receives the acceleration information and MDIS determines that the drone is moving forward. Therefore, the MDIS method selects the forward motion search model to be used in ME for encoding the current video frame.

Using a probability_threshold set to 0.5, MDIS starts with calculating the search probabilities for a CU located at position (16, 16) —the upper left position in the video frame.

MDIS is designed to identify which diamond search locations should even be considered, and which not, so it calculates the probabilities to determine which probabilities are greater than the probability_threshold.

### The Upper Left Position of the Diamond:

$$P ( x , y ) = ( x + y ) / ( w + h ) = ( 16 + 16 ) / ( 3840 + 2160 ) = 32 / 6000 = 0.0053 .$$

Since P(x, y)<probability_threshold, the upper left search location will not be searched for the CU at (16, 16).

### The Straight-Up Position of the Diamond:

$$P ( x , y ) = y / h = 16 / 2160 = 0.0074$$

Since P(x, y)<probability_threshold, the straight-up search location will not be searched for the CU at (16, 16).

### The Upper Right Position of the Diamond:

$$P ( x , y ) = ( \vert x - w \vert + y ) / ( w + h ) = 0.64$$

Since P(x, y)>probability_threshold, the upper right search location will be searched for the CU at (16, 16).

### The Left Position of the Diamond:

$$P ( x , y ) = x / w = 0.0042$$

Since P(x, y)<probability_threshold, the left search location will not be searched for the CU at (16, 16).

### The Center Position of the Diamond:

P(x,y)=0.0099

Since P(x, y)<probability_threshold, the center search location will not be searched for the CU at (16, 16).

### The Right Position of the Diamond:

P(x,y)=0.996

Since P(x, y)>probability_threshold, the right search location will be searched for the CU at (16, 16).

### The Bottom Left Position of the Diamond:

P(x,y)=0.36

Since P(x, y)<probability_threshold, the bottom left search location will not be searched for the CU at (16, 16).

### The Bottom Position of the Diamond:

P(x,y)=0.993

Since P(x, y)>probability_threshold, the bottom search location will not be searched for the CU at (16, 16).

### The Bottom Right Position of the Diamond:

P(x,y)=0.9947

Since P(x, y)>probability_threshold, the bottom right search location will be searched for the CU at (16, 16).

To conclude, the application of the method for the CU at (16, 16), only the upper right, right, bottom and bottom right locations of the diamond will be searched—which logically makes sense if we consider how the image changes during the forward drone motion. During the forward drone motion, pixels expand towards the edges of the image, so the method will focus on searching the locations pointing towards the center of the image (see FIG. 4).

### Using the MDIS Method to Calculate the CU at Location (2000, 2000)

### The Upper Left Position of the Diamond:

P(x,y)=0.666.
Since P(x, y)>probability_threshold, the upper left search location will be searched for the CU at (2000, 2000).

### The Straight-Up Position of the Diamond:

P(x,y)=0.9259
Since P(x, y)>probability_threshold, the straight-up search location will be searched for the CU at (2000, 2000).

### The Upper Right Position of the Diamond:

P(x,y)=0.64
Since P(x, y)>probability_threshold, the upper right search location will be searched for the CU at (2000, 2000).

### The Center Position of the Diamond:

P(x,y)=0.581
Since P(x, y)>probability_threshold, the center search location will be searched for the CU at (2000, 2000).

### The Right Position of the Diamond:

P(x,y)=0.479
Since P(x, y)<probability_threshold, the right search location will not be searched for the CU at (2000, 2000).

### The Bottom Left Position of the Diamond:

P(x,y)=0.36
Since P(x, y)<probability_threshold, the bottom left search location will not be searched for the CU at (2000, 2000).

### The Bottom Position of the Diamond:

P(x,y)=0.074
Since P(x, y)<probability_threshold, the bottom search location will not be searched for the CU at (2000, 2000).

### The Bottom Right Position of the Diamond:

P(x,y)=0.334
Since P(x, y)<probability_threshold, the bottom right search location will not be searched for the CU at (2000, 2000).

The upper left position of the diamond: In this example, for the CU at (2000, 2000), only the upper left, straight-up, upper right, left and center positions of the diamond will be searched—which again aligns with how the pixels tend to expand towards the edges of the image in a forward drone motion.

The basic idea being that one can research the grayscale images in FIG. 8, representing the search probabilities for certain search locations depending on the CU location—the lighter the area, the higher the probability.

The Motion Dynamics Estimator Block is a block that interpolates inside the standard video encoder and instructs the Motion Estimation block which locations will be searched. It is located in the processing unit of the Unmanned System (UxS).

Given that tests used to verify the efficiency of the present method were performed on simulator footage as well as on real 4K drone sequences, the Motion Dynamics Estimator Block was customized to suit these particular scenarios.

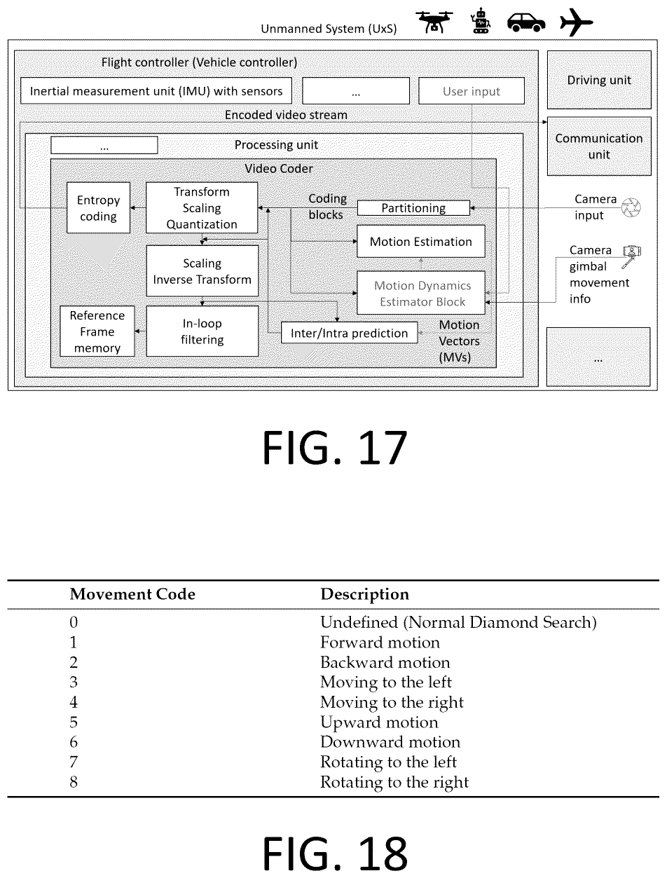

The Motion Dynamics Estimator Block in FIG. 17 can be imagined as a ‘black box’ which estimates motion dynamics depending on several parameters, such as the mounting point of the camera (given as an offset from the origin of the vehicle's frame of reference), the default pose of its viewport and user inputs from the controller.

Whether the camera is firmly fixed or mobile (attached to a gimbal) is also factored into calculations performed by the MDIS method.

A semantic description of the MDIS method is as follows:
Determine the starting MV—Use the AMVP scheme.
Collect data—Obtain data from the Motion Dynamics Estimator block (globally de-fined parameters mentioned earlier and user input from the controller).
Process data—Analyze the collected data to determine the appropriate search model for the current frame.
Perform integer-block search—Use the determined search model to conduct the integer-block search.
Refine the MV—Apply fractional search to refine the MV.

Even though our system has been developed to allow use of the MDIS method in real time, the tests for this research were made using pre-recorded footage and accompanying log files which include user input.

For example, the input received from the user has the following format:

Right Stick Vertical−[3.319998]→−0.3877063

In this example, the Right Stick Vertical, which corresponds to the forward motion, was pushed with the intensity of −0.3877063 at the second 3.319998.

Generally, the received input follows the following format:

STICK−[TIMESTAMP]→INTENSITY
The time stamp can easily be converted into the frame number, and the intensities range from −1 to 1.

The idea is to use the received input to generate a textual file that contains numbers from ‘0’ to ‘8’, which corresponds to all the possible movements, starting with ‘0’, which means undefined (perform a normal DS), ‘1’ for forward motion, ‘2’ for backward motion, ‘3’ for moving to the left, and so on (FIG. 18).

The MDIS method then employs an algorithm that reads those numbers and uses a specific search model depending on the read number. The accuracy of the utilized motion dynamics estimation is ensured by relying on the same input data already used for controlling the drone, which is handled and secured by the drone's manufacturers.

Since this information is integral to the drone's operation, it is inherently accurate and reliable. Even if an error occurs, it would not cause a significant issue because such errors are rare and because ME uses the AMVP scheme described earlier in this section, which is robust to rare disturbances. For example, we tested this by intentionally inserting a random value in the generated textual file at every 20th character location, and the impact on ME quality was negligible.

While integrating additional sensor data such as radar or laser data could potentially enhance the precision of motion dynamics estimation, our primary focus is on leveraging joystick input data.

This decision is based on the following factors:
Data availability and reliability: joystick input data are readily available and reliably processed by the drone's control system. These data are directly tied to the user's commands and provide immediate feedback on the intended movements.
Integration complexity: incorporating radar or laser data would introduce additional complexity into the system. These sensors require calibration, synchronization, and integration with the existing control and processing framework.

Incorporating this level of sophistication into sensor systems is challenging and may necessitate significant changes to the hardware and software architecture which results in making the required modifications to these systems without adding significant encumbrances on the processing speed which would affect the timely delivery of results, a novel method.

Another important factor to consider is that the inventive step lies in the identification of the direction of acceleration, not just the drone's movement. This is due to the fact that MVs are refined based on a starting MV.

For instance, if the drone is moving forward but begins to decelerate, the backward motion model should be employed, despite the drone's continued forward motion. The same goes with all other movement types, not just the forward/backward motion.

Very small accelerations and decelerations are not problematic, because the fractional pixel search, which is unchanged in MDIS, can handle small changes in MVs. Specifically, this last case of small changes in acceleration refers to cases in which the user's fingers aren't completely steady, so the joystick push intensities can slightly vary from frame to frame.

To conclude, the MDIS version embodied in the present invention determines the final movement codes by following the described principles:
Consecutive frames condition—A joystick had to maintain the highest push intensity for several consecutive frames (eight in the tested MDIS version). Only after this consistency was maintained over several frames did the corresponding movement code start being written to the final direction output file.
Acceleration threshold condition—To ensure we are capturing acceleration, the stick push intensity in the current frame had to differ from the previous frame by a specific threshold (e.g., 0.05). If any of these conditions were not met, a ‘0’ was written to the final directions output file.

In the current MDIS embodiment, the nine search modes are implemented. The combinations of multiple models, such as forward and downward motion are not yet implemented. Whenever it is unclear which search model should be used, a ‘0’ is written in the textual movement file, which means a normal DS is used for that frame.

This is an improvement that can be implemented in future embodiments based on the present method.

1. Method for real time calculation of video coding motion vectors using direction and acceleration information from a device or vehicle comprising:
receiving movement information relating to a device or vehicle in motion with a programmable video encoder;
using an image processing search algorithm designed to incorporate block search points and calculating motion vectors;
collecting block search information based on block location and movement information received about the motion of the device or vehicle;
analyzing movement in camera viewpoint;
adjusting parameters with properties of the camera lens, including field of view, lens curvature and the geometry of block distribution on the video image in calculating motion dynamic input search points; and
replacing block search points which are not identified by the method with block search points which are identified by the claimed method.

2. The method of claim 1 wherein the method utilizes movement information received from a fixed camera comprising an estimation of the camera viewport position and applying the method of claim 1 to identify the MDIS point vector.

3. The method of claim 1 wherein the method utilizes movement information received from a camera in motion comprising the additional step compensating the method to parameterize real time movement of the camera viewport position and applying the method of claim 1 to identify the MDIS point vector.

4. An image processing system, comprising:
a processor enabled to implement or perform calculations to identify block search points based on block location and movement information of a device or vehicle in motion to process movement in camera viewpoint;
applying steps to identify preferred block search points; and
removing block search points which are not identified by the system.
